(19) United States
(12) Patent Application Publication
(10) Pub. No.: US 2010/0019927 A1
(43) Pub. Date: Jan. 28, 2010

(54) PRIVACY ENSURING MOBILE AWARENESS SYSTEM

(76) Inventor: Seth Cirker, Port Washington, NY (US)

Correspondence Address: HOLLAND & HART LLP, 60 E. South Temple, Suite 2000, P.O. Box 11583, Salt Lake City, UT, 84110, US

(21) Appl. No.: 12/550,155

(22) Filed: Aug. 28, 2009

Related U.S. Application Data
(63) Continuation-in-part of application No. 11/717,806, filed on Mar. 14, 2007.

(51) Int. Cl. G08C 19/00; H04B 1/00; H04N 7/18

(52) U.S. Cl. 340/825.69; 381/86; 348/148; 348/E07.085

(57) ABSTRACT

A selectively activated mobile awareness system fit into a vehicle includes a processing unit with a memory system and an input/output system. Situation monitoring equipment is connected to the input/output system of the processing unit. A control mechanism is used to instruct the processing unit to alert a remote location and display data collected from the monitoring equipment.

### RELATED APPLICATIONS

The present application is a continuation-in-part of pending application Ser. No. 11/717,806, filed Mar. 14, 2007, titled “Selectively Enabled Threat Based Information System”, which application is incorporated herein by reference in its entirety.

### TECHNICAL FIELD

The present exemplary system and method relate to surveillance, monitoring, and security devices. More particularly, the present exemplary system and method relate to controlling a mobile awareness system which may be used by law enforcement operatives and agencies.

### BACKGROUND

Law enforcement operations often involve sting operations and other undercover methods. Any information related to the planning and carrying out of these types of operations is highly limited. Typically, only those involved directly with the operation are informed. The more information of this nature is shared, the more likely it is that details of the operation could become known to the public or the targeted suspects. Not only does the leaking of information jeopardize the operation, but can put the lives of law enforcement operatives in danger.

One issue with limiting the information about these types of operations is that it gives the law enforcement operative limited resources. Operatives in these situations must often act as independent units without additional supervision, support, and backup from other operatives or agencies that are typically available. Though privacy during these types of operations can be very useful, it may also introduce additional safety risks.

Similarly, law enforcement officers frequently work alone or in small units as the need for additional supervision, support and backup from other operatives or agencies is unanticipated. Often nonviolent events such as traffic stops, investigations and interrogations escalate into dangerous situations causing officers to be less prepared than they would have been if such unpredictable events were anticipated.

In general, if an operative is involved in a sting operation or working without adequate resources and a high risk situation arises, there is no immediate means by which to make other operatives or agencies fully aware of the situation. When the life of the operative is put in danger, the operative is without the supervision, backup and support from other operatives or agencies that would typically be available.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustrative diagram of an exemplary mobile awareness system, according to one embodiment of principles described herein.

FIG. 2 is an illustrative depiction of a top view of the exterior of a law enforcement vehicle fit with an exemplary mobile awareness system, according to one embodiment of principles described herein.

FIG. 3 is an illustrative depiction of a top view of the interior of a law enforcement vehicle fit with an exemplary mobile awareness system, according to one embodiment of principles described herein.

FIG. 4 is an illustrative depiction of an exemplary location in which a law enforcement vehicle fit with a mobile awareness system may be used, according to one embodiment of principles described herein.

FIG. 5 is an illustrative depiction of an exemplary graphical user interface for a dispatcher, the user interface displaying information received from a mobile awareness system, according to one embodiment of principles described herein.

FIG. 6 is a flow chart depicting an exemplary process of activating a mobile awareness system, according to one embodiment of principles described herein.

Throughout the drawings, identical reference numbers designate similar, but not necessarily identical, elements.

### DETAILED DESCRIPTION

As mentioned above, law enforcement operatives can be put in dangerous situations when running an undercover operation. Due to a need for privacy, very few individuals are informed of the details of an operation. As a result, operatives or agents involved with an undercover operation are often put in a dangerous situation as they do not have the typical supervision, support, and backup which is normally available.

The present specification relates to a mobile awareness system. According to one illustrative embodiment, an awareness system fit into a vehicle comprises cameras and wireless communication ability. The operative carries a small device which will set the awareness system to a transmitting mode, thus alerting authorities at a remote location. If necessary, those authorities can provide assistance to the operative. The operative has the option to use the system if the threat level of the situation is raised too high and the operative feels in danger.

While the present exemplary system and method are described in the context of a mobile system, according to one illustrative embodiment, the awareness system may be placed at a location. For example, the awareness system may be attached to or integrated with a light pole. The awareness system may be placed in a boat, house or a building. The awareness system can be set up to survey a variety of locations in which an operative may feel relevant for a particular objective.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

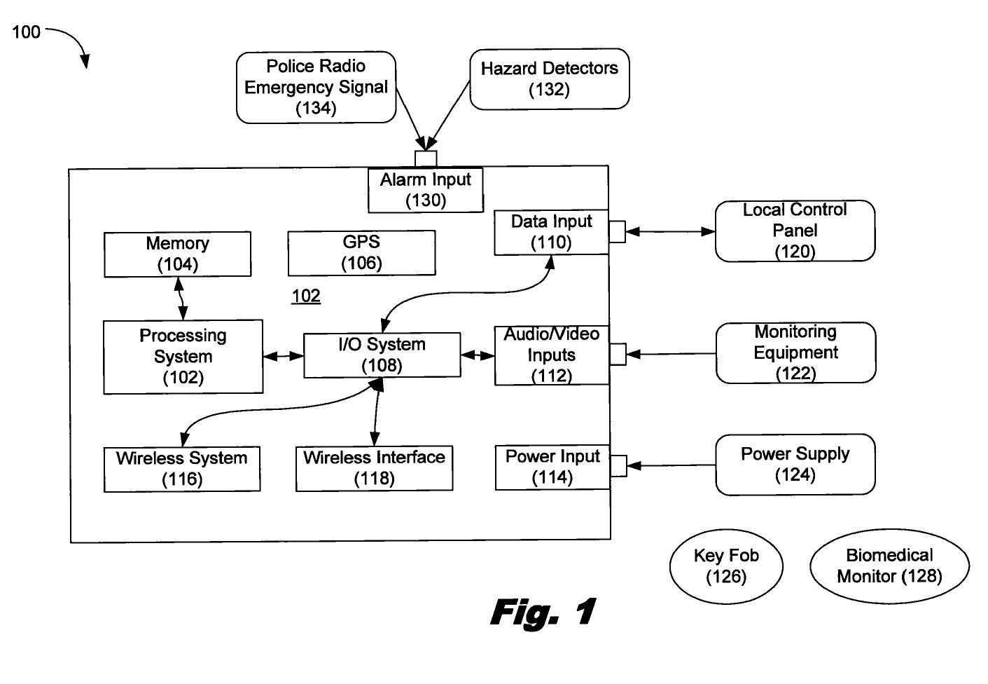

FIG. 1 is an illustrative diagram of an exemplary mobile awareness system (100). According to one illustrative embodiment, a vehicle may contain a “box” (102) containing components for a mobile awareness system (100). The box, according to one exemplary embodiment, contains a memory component (104). The memory component may be made of any type including but not limited to flash, magnetic, or any other type of storage medium. The memory (104) may be removable, embedded, or both. For example, the memory system may include a secure digital (SD) card which is removable and able to be accessed by other electronic devices. The box (102) may have the option of having a global positioning satellite (GPS) system (106), allowing the vehicle to be tracked by agency dispatchers.

The box contains a main processing system (102) which processes all the data necessary for operation. An input/output (I/O) system (108) interfaces with all input or output media. The box may contain a wireless communication system (116) with which to communicate with a remote location such as agency dispatch or headquarters if necessary. The wireless system (116) can also transmit any data which has been collected from attached monitoring equipment (122) such as cameras or audio recording devices. The box (102) may contain external ports in which additional components may be attached. A data input port (110) may be used to connect a control panel (120) to the box (102), allowing an operative to adjust settings or send instructions to the mobile awareness system (100). For example, the operative may be able to enter information about the current operation that will be displayed at agency headquarters if the mobile awareness system (100) is set into a transmitting mode. Audio/Video ports (112) may be used to connect to various monitoring equipment (122) including but not limited to, cameras, wired and wireless microphones, motion detector and foreign substance detectors. There may be a power port (114) used to connect the box (102) to an external power supply (124) such as the power supply of the vehicle in which the mobile awareness system (100) is placed in. In one embodiment, the box (102) contains its own power supply (124).

In one embodiment, the box (102) contains a wireless interface (118) in which the box (102) contains the necessary components to communicate and receive instructions from a device such as a key fob transmitter (126) which is carried by the operative. Through this device (126), the operative may activate the system (100). During normal sting operations, the system may be in a normal mode in which any recording of audio or visual information is stored on the local memory system. When the system (100) is set into a transmitting mode, the audio and video feeds may be transmitted wirelessly to agency dispatch or headquarters. By transmitting the data, the operative can receive backup or support from other operatives. If the sting operation goes according to plan and the officer never perceives that they are in danger, the operative may choose not to activate the mobile threat based security system (100). In one embodiment, the key fob (126) itself may be disguised as any other small object so as not to arouse suspicion.

In one embodiment, this wireless interface (118) contains the necessary components to communicate and receive instructions from an automated wireless device such as a “man down indicator” or “biomedical monitor” (128) which is carried by the operative. Through this device (128), the system (100) may be also activated.

In one embodiment, the box (102) may contain an alarm input (130) in which the box (102) contains the necessary components to communicate and receive instructions from other devices such as chemical, biological and nuclear radiation detectors, gunshot detectors (132), or the emergency signal from a police radio system (134). Through these devices (132, 134), the system may be activated.

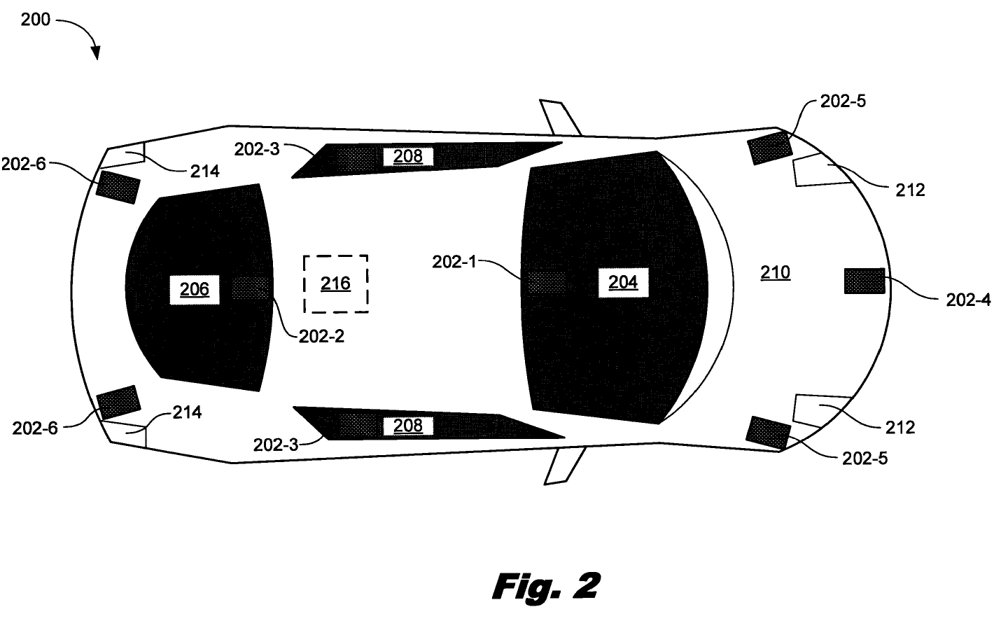

FIG. 2 is an illustrative depiction of a top view of the exterior of a law enforcement vehicle (200) fit with an exemplary mobile awareness system (100, FIG. 1). Though FIG. 2 shows multiple pieces of monitoring equipment (202-1 to 202-6), an embodiment of the innovation described herein may contain one or any number of monitoring devices.

In one embodiment, a law enforcement vehicle (200) may have multiple cameras (202-1 to 202-6). A camera (202-1) may be positioned in the front windshield (204) and a camera (202-2) in the back windshield (206). There may also be cameras (202-3) in the side windows (208). These cameras may be disguised as other objects or otherwise hidden so as not to arouse suspicion. Additionally, according to one exemplary embodiment, a camera (202-4) may be placed in front of the vehicle (210) as well as cameras (202-5) near the headlights (212). There may also be cameras (202-6) near the tail lights (214). Cameras may also be placed in any other location throughout the vehicle. In some embodiments, only one camera may be used. Microphones and other pieces of monitoring equipment such as chemical, biological, nuclear radiation detectors and gunshot detectors may be placed throughout the vehicle (200) as well. The external cameras may be caused to rotate both horizontally and vertically so as to allow a better view for monitoring various situations. The exact angles at which the cameras are placed may be controlled from a local control panel available in the vehicle.

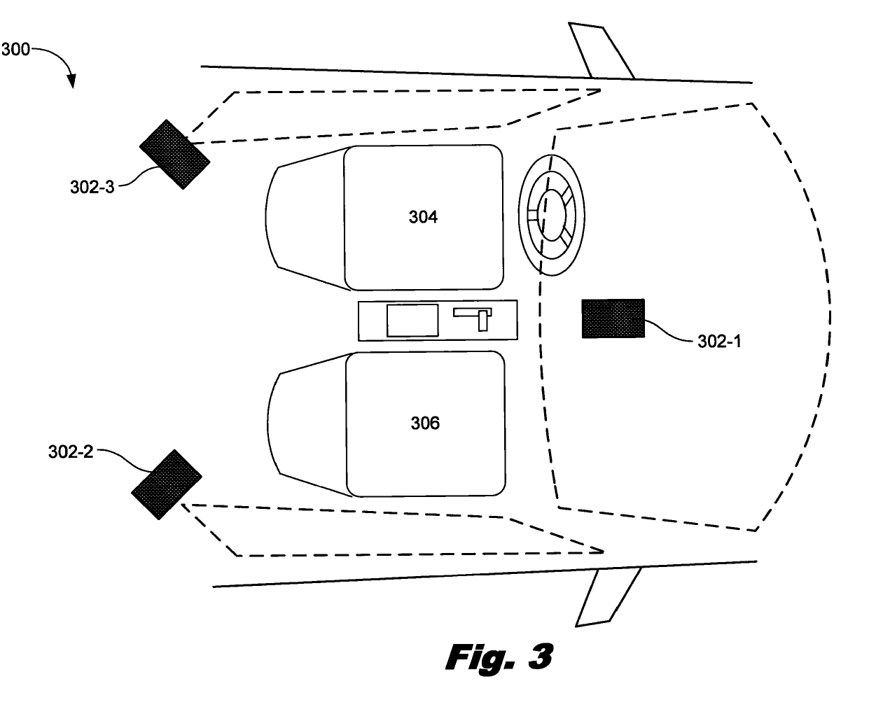

FIG. 3 is an illustrative depiction of a top view of the interior (300) of a law enforcement vehicle (200, FIG. 2) fit with an exemplary mobile awareness system (100, FIG. 1). In some operations, a suspect may enter an agent's vehicle wherein discussions may take place. Cameras and other monitoring equipment such as a microphone may be directed toward the interior (300) of a vehicle. Though three cameras are shown in FIG. 3, the interior (300) of a vehicle may be fit with only one or any number of hidden cameras. In one embodiment a camera (302-1) is hidden somewhere in the dashboard. This camera (302-1) gives a view of both the person in the driver seat (304) and the person in the passenger seat (306). Additionally, there may be a camera (302-2) in the back right giving a back-side view of the person in the driver seat (304). There could also be a camera (302-3) somewhere in the back left giving a view of the person in the passenger seat (306).

The interior monitoring system (300) may be in a standard mode in which the system may record both audibly and visually any activity occurring within the interior of the vehicle (300). The recording data may be stored in the memory (104, FIG. 1) of mobile awareness system (100, FIG. 1). The operative or agent running the sting operation may choose to set the awareness system in a transmitting mode if the operative or agent feels the risk is high or for any other reason. While in transmitting mode, the awareness system may transmit the recorded data to the agency dispatch or headquarters. Other authorities may then receive information relating to the operation and offer assistance if necessary.

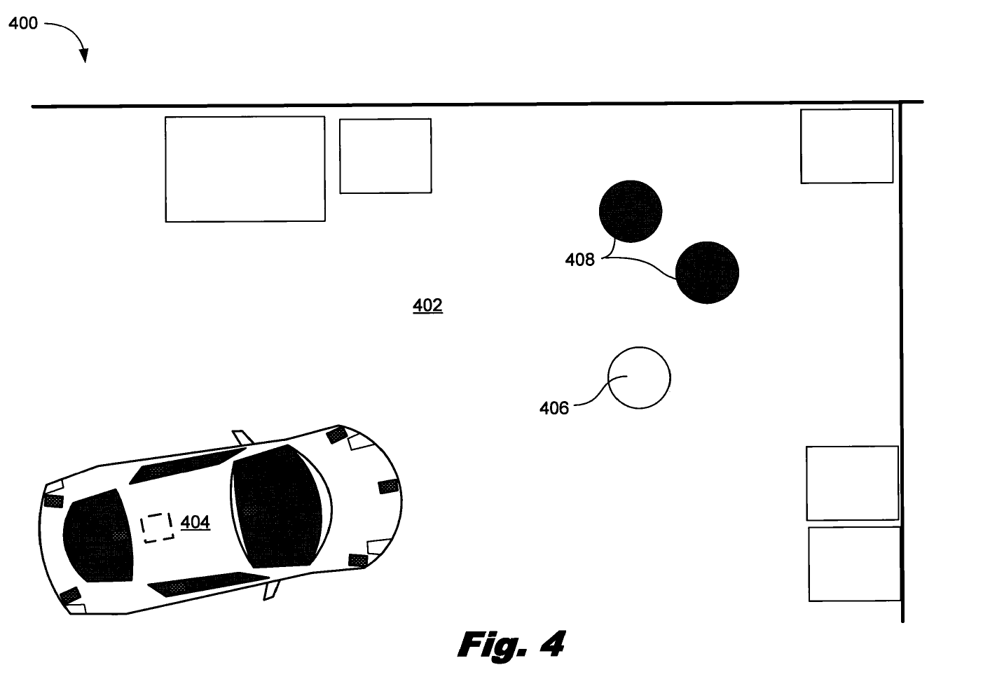

FIG. 4 is an illustrative depiction of an exemplary location in which a law enforcement vehicle fit with a mobile awareness system may be used. The exemplary scene (400) shown in the figure is in a corner (402) of an alley. However, a vehicle fit with an awareness system embodying principles described herein may be used in any scene or setting.

According to exemplary scenario, an operative pulls up to a corner where an event is taking place. The vehicle is placed in a manner which allows external cameras to monitor the location (402). The awareness system will be in a standard mode in which it is not transmitting any data. The operative (406) may carry a key fob (126, FIG. 1) which will change the mode to a transmitting mode in which agency dispatch or headquarters is alerted and given information relevant to the current operation. The operative (406) may choose to change the mode to a transmitting mode if felt threatened by the suspects (408) or for any other reason.

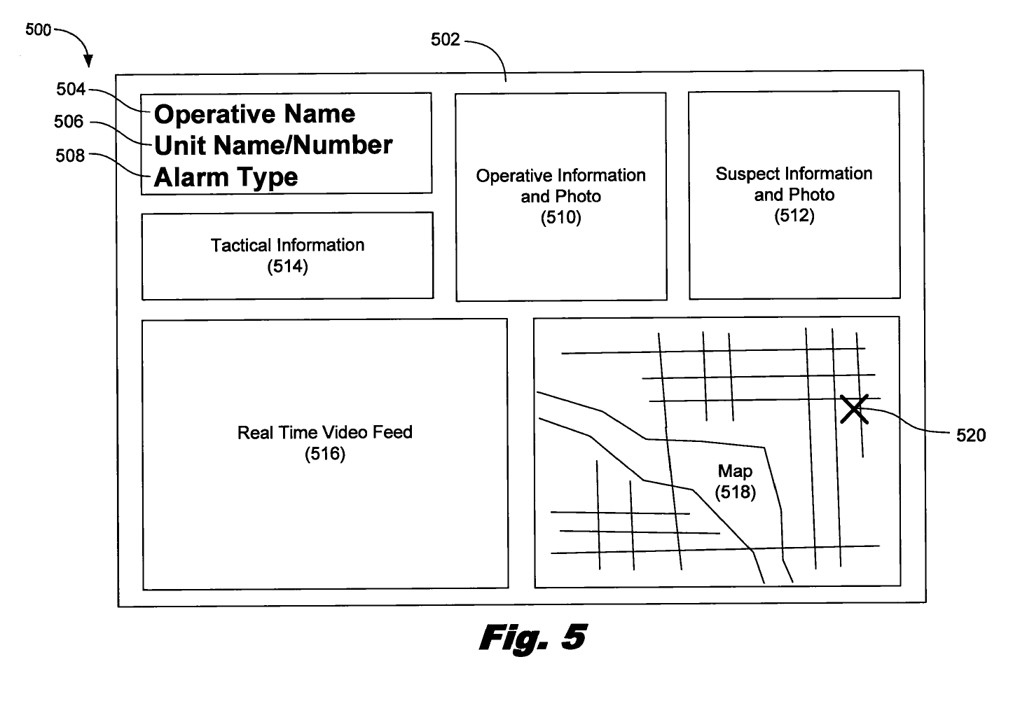

FIG. 5 is an illustrative depiction of an exemplary graphical user interface (GUI) (500) for a dispatcher, the user interface displaying information received from a mobile awareness system (100, FIG. 1). According to one illustrative embodiment, the mobile awareness system can be set to transmit data back to agency dispatch or headquarters. Upon transmission, a monitor at dispatch displays information related to the undercover operation, thus making the operation known to the rest of the agency. This will allow the undercover operative to receive supervision, support and backup assistance if necessary.

In one embodiment, the GUI (500) displays the operative's name (504), the unit number (506) the operative belongs to, and the type of alarm (508) the operative is sending. It may be the case that the operative only wants dispatch to be able to view and not send backup. It may also be the case that the operative feels threatened and wants backup there as soon as possible. The operative can specify the type of help needed from the key fob connected to the awareness system. The GUI (500) may display information (510) about the operative such as a photograph, physical characteristics or description of the undercover agent's attire. Information (512) about the suspect such as a photograph and physical characteristics may also be shown.

Information relating to the specific mission the operative is involved in may also be shown. Detailed tactical information (514) related to the operation may be displayed. This information may be transmitted to agency headquarters whether the system is activated or not. The tactical information (514) would then be displayed only when the operative activates the system. This would minimize the amount of data that would need to be transmitted during an emergency. Real time video feeds (516) from the hidden cameras of the awareness system may be displayed as well. If the awareness system includes a GPS system, a map (518) showing the operative's location may be displayed. Having these details of an operative and the operation may help to ensure the safety of the operative if the situation becomes too dangerous.

The GUI (500) described herein and shown in FIG. 5 is merely an example of one possible format and layout of a GUI (500) for a mobile awareness system. Any layout may be used for the GUI (500). In addition, a GUI (500) embodying principles described herein is not limited to the information displayed in FIG. 5. An applied GUI (500) may have additional information or less information displayed according to different embodiments.

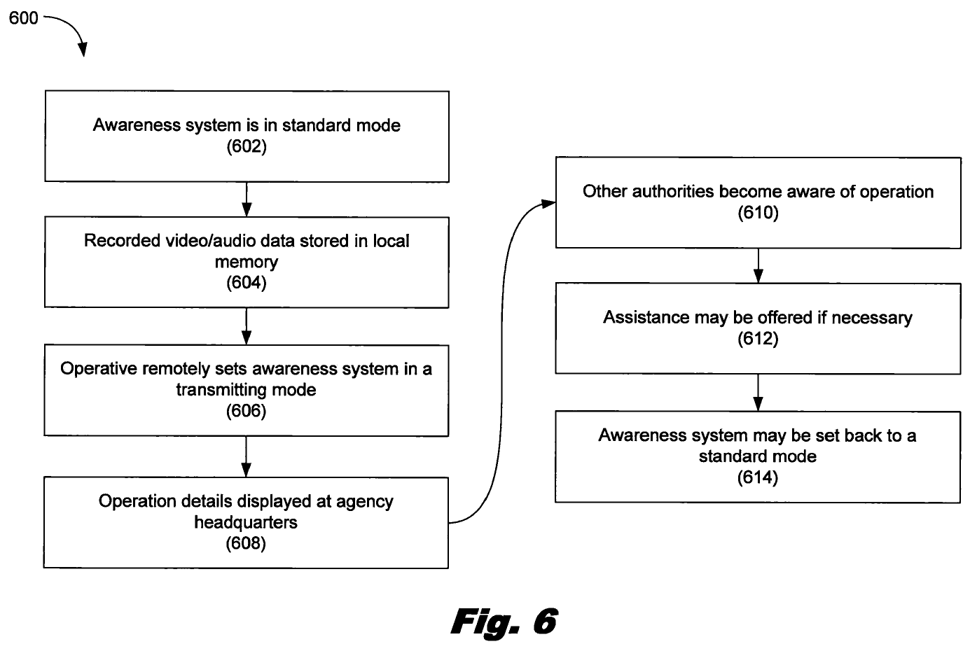

FIG. 6 is a flow chart (600) depicting an exemplary process of activating a mobile awareness system which has been fit into an undercover vehicle. According to one exemplary process, the mobile awareness system normally operates in a standard mode (602). While in standard mode, if the operative sets the system to record audio and visual inputs from hidden cameras and microphones, all data is stored locally in the memory system (604). If for any reason, the operative believes it to be an advantage to alert agency headquarters of the situation, the operative can “activate” the awareness system by setting it to a transmitting mode (606). The officer can either do this from a control mechanism within the vehicle, or remotely with a key device which is wirelessly connected to the mobile awareness system. While in transmit mode, details of the operation and real time video will be available at agency headquarters (608). This allows other authorities to become aware of the operation (610). The officer may then be given supervision, support, and backup assistance if necessary (612). When the situation is over or for any other reason, the system may be set back to a normal mode (614). Agency headquarters will no longer receive the video or audio feeds.

In sum, a mobile awareness system is fit into the vehicle of an operative or any location as determined a valuable placement by an operative. During normal operation the data gathered by the monitoring equipment is recorded onto local memory media. If the operative feels the need to alert agency headquarters of the situation, the operative may set the awareness system to transmit information related to the operation and any video or audio feeds associated with the awareness system. The operative may set the mode of the system remotely through a wireless device, or locally through some control mechanism.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A mobile awareness system, comprising;
a processing unit including a memory system and an input/output system;
monitoring equipment connected to said input/output system;
a control mechanism connected to said processing unit used to set the system to transmit monitored data to a remote location;
wherein said system is activated by a remote device, said remote device being wirelessly interfaced with said mobile awareness system.

2. The system of claim 1, wherein said mobile awareness system is disposed within said vehicle, and wherein said monitoring equipment is placed somewhere within said vehicle.

3. The system of claim 1, wherein said mobile awareness system is placed at a location, said processing unit is hidden at said location, and said monitoring equipment is placed at said location.

4. The system of claim 1, wherein said memory system is embedded in said processing system.

5. The system of claim 1, wherein said memory system is removable from said processing system.

6. The system of claim 1, wherein said monitoring equipment comprises at least one video camera.

7. The system of claim 1, wherein said monitoring equipment comprises at least one microphone.

8. The system of claim 1, wherein said monitoring equipment is concealed.

9. The system of claim 1, wherein said processing unit comprises a GPS system.

10. The system of claim 1, wherein said control mechanism is disposed within the vehicle.

11. The system of claim 1, wherein said control mechanism comprises a remote control device wirelessly connected to said processing unit.

12. The system of claim 1, wherein said monitoring equipment is configured to monitor an interior space of said vehicle.

13. The system of claim 1, further comprising an input device configured to allow an operator to input additional information to be transmitted to said remote location when said system is set to transmit.

14. A method for transmitting monitored data from a mobile awareness system to a remote location, comprising;
fitting a vehicle with said mobile awareness system;
placing the vehicle within a location to be surveyed;
causing said awareness system to selectively transmit data to a remote location,
wherein said awareness system is in a non-transmitting mode until instructed to transmit by a control mechanism.

15. The method of claim 14, wherein said monitoring equipment monitors the interior and the exterior of said vehicle.

16. The method of claim 14, wherein said awareness system comprises a global positioning system (GPS).

17. The method of claim 14, wherein said awareness system comprises at least one camera and at least one microphone.

18. The method of claim 17, wherein said camera and said microphone are concealed within said vehicle.

19. The method of claim 14, wherein said control mechanism comprises a remote control device wirelessly connected to said awareness system.
